(19) United States
(12) Patent Application Publication
(10) Pub. No.: US 2007/0033579 A1
(43) Pub. Date: Feb. 8, 2007

(54) System and method for searching for multiple types of errors in file following translation into a new natural language

(75) Inventors: James Neal Andrews, Austin, TX (US); Joseph C. Ross, Georgetown, TX (US); Lum Elijah Twilligear III, Austin, TX (US); Keiichi Yamamoto, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 11/195,022

(22) Filed: Aug. 2, 2005

(51) Int. Cl. G06F 9/45; G06F 9/44

(52) U.S. Cl. 717/136; 717/101

(57) ABSTRACT

A system and method is provided wherein a software file or packaged set of files, originally prepared in one natural language, is sent to a translator for translation into another natural language. The translated file or files is then delivered back from the translator, to an automated error checking tool. The tool performs a number of different error checking functions on the file, to determine if the file has any of a number of different types of errors resulting from the translation. Usefully, different error checking devices are provided to search for errors of different types or classes. The tool is operated in association with a firewall, to ensure that files with errors cannot be introduced into the software development-build environment. The translator is automatically notified via electronic mail if errors are found in his/her files.

### BACKGROUND OF THE INVENTION

1. Technical Field

The invention disclosed and claimed herein generally pertains to a system and method for automatically checking for errors in a file or files related to a software development project translated into a new natural language. More particularly, the invention pertains to a system of the above type wherein the translator is automatically notified of any detected or discovered errors. Even more particularly, the invention pertains to a system of the above type that is adapted to check for a multiplicity of different types or classes of translation-induced errors.

2. Description of Related Art

It is increasingly common for a software file to be translated from one natural language to another, as part of a software development project or the like. As used herein, the term “natural language” refers to a human language such as, by way of example and not limitation, English, Spanish or Chinese. However, notwithstanding numerous benefits, the process of translating software from one natural language into another frequently introduces errors into the translated software, even where the software was error-free prior to translation. This is clearly undesirable, particularly where the translated software file is sent into an environment for use in further software development. Introducing translation-induced software errors into a software project has often caused major adverse impact to software release schedules, and has increased costs of software development.

Previous efforts to find translation-induced errors in software files have generally been limited to detection of errors of only a single type or class, with errors usually found after the translated file has been introduced back into the software development environment. However, there are a substantial number of different types of translation-induced errors, any one of which may have significant undesired effects on the software in which the error resides. Moreover, presently used methods for detecting translation errors in software tend to require comparatively large amounts of manual effort by a user. Accordingly, it would be beneficial to enhance automation, in searching for translation-induced errors in a software file translated into a new natural language. It would be of further benefit to provide the capability to automatically search for multiple types of translation-induced errors, and to prevent files containing such errors from entering a software development environment.

It is to be understood that throughout this application, the term “file” refers to either a single file relating to a software development project or a set of files relating to a software development project that have been packaged into a single file archive, such as TAR (Tape Archiver) or ZIP file, through the use of a standard computer file compression utility.

### SUMMARY OF THE INVENTION

The invention disclosed herein is generally directed to a system and method wherein a software file, translated into a new natural language from another natural language, is delivered from the translator to an automated error checking tool. The tool performs a number of different error checking functions on the file, which may include, by way of example and not limitation, tasks such as confirmation of the codeset of the file being delivered; confirmation that code parts of the file have not been changed; and a test compilation of the file. The tool is operated in association with a “firewall”, to ensure that files with errors cannot be introduced into the software development-build environment. If any errors are found, the translator is automatically notified that the file will not be allowed through the firewall into the development environment. One embodiment of the invention, directed to a system for checking a software file translated into a specified natural language, includes a plurality of error checking devices respectively coupled to receive the translated file. A first error checking device included in the plurality is disposed to provided a first output indicating whether any portion of the translation has a first type of error. A second error checking device, likewise included in the plurality, is similarly disposed to provide a second output indicating whether any portion of the translation has a second type of error, wherein the second type of error is different from the first type of error. A firewall device responsive to the first and second outputs is provided to prevent the translated file from entering a software development environment when either of the outputs indicates that one or more translation-introduced errors has been found in the translated file.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a block diagram depicting components of an embodiment of the invention;

FIG. 2 is a block diagram showing a simplified error checking device for the embodiment of FIG. 1;

FIG. 3 is a flowchart illustrating an embodiment of the invention; and

FIG. 4 is a block diagram showing a simplified system control for the embodiment of FIG. 1.

### DETAILED DESCRIPTION OF THE PREFERRED EMBODIMENT

Referring to FIG. 1, there is shown a translated file 102 sent from a translator 104 to an error checking tool 106, constructed in accordance with an embodiment of the invention, by means of a communication path or channel 108. At least a portion of path 108 is usefully directed along the Internet. Translated file 102 comprises a software file that has been translated into a new natural language from a previous or original natural language by translator 104.

FIG. 1 further shows error checking tool 106 comprising error checking devices 110-114, also referred to as error checking devices A, B and C, respectively. The devices 110-114 are provided to search for different types or classes of translation errors in translated file 102, as described hereinafter in further detail. While FIG. 1 shows error checking tool 106 provided with three error checking devices, it will be understood that other embodiments of the invention could comprise other pluralities of error checking devices, each constructed or configured to check translated file 102 for a different type of translation error.

FIG. 1 shows translated file 102 received first by error checking device A, and then transmitted sequentially therefrom to error checking device B and finally to error checking device C. While this route for file transmission has certain benefits, it is to be appreciated that in other embodiments of the invention different routes may be used for transmitting the file 102 to respective error checking devices. For example, the translated file 102 could be sent simultaneously to each error checking device, along parallel transmission paths.

FIG. 1 also shows error checking devices A, B and C respectively providing outputs OP_{A}, OP_{B} and OP_{C}. Each output indicates whether its corresponding error checking device has or has not found any errors in translated file 102, of the error type or class that the device is constructed to search for. Usefully, if a device has found any errors in file 102, the device output will identify each error and will indicate its location in file 102. FIG. 1 shows the outputs of error checking devices A and B routed through error checking device C. This routing is done for convenience and is in no way intended to limit the scope of the invention.

Referring further to FIG. 1, there is shown the output of error checking tool 106, which also is the output of device 114, coupled to a firewall device 116. The output of tool 106 comprises translated file 102, and further comprises the respective outputs OP_{A}, OP_{B} and OP_{C} of error checking devices 110-114. Device 116 is configured to determine, from the error checking device outputs, whether or not any errors were found in the translated file 102 by any of the error checking devices 110-114. If no errors were found, as indicated by each of the outputs OP_{A}, OP_{B}, and OP_{C}, device 116 operates to direct the translated file 102 along a transmission path 122, through a boundary between software translation and software development, to a development environment 118. The translated file 102 can then be used in connection with a software development project that requires file 102, as translated into the new natural language.

In the event that firewall device 116 detects one or more errors in any of the error checking device outputs, device 116 will not allow translated file 102 to enter development environment 118. Instead, firewall device 116 will send a message to translator 104 along a path 124, to notify the translator that one or more errors have been discovered in translated file 102. Usefully, the error checking device outputs OP_{A}-OP_{C} are also sent to the translator 104, to specifically identify each discovered error.

In one useful embodiment, each error checking device 110-114 would include a coded signal in its output that indicated whether the device did or did not find any errors in translated file 102. The firewall device 116 could then be a device capable of reading the coded signal in each output, and then respond thereto by either sending the file 102 along path 122, or by sending the outputs OP_{A}-OP_{C} along path 124, as described above.

FIG. 1 further shows a system control 120 coupled to control and coordinate operations of error checking tool 106, error checking devices 110-114, and firewall device 116.

Examples of the classes or types of errors that different error checking devices of tool 106 could search for include package completeness; package correctness; code content; syntax; workable compilation; and correct codeset or encoding. Thus, error checking device A of FIG. 1 could check for package completeness, device B could check for package correctness, and device C could search the translated file for errors in code content. Tool 106 could be provided with further error checking devices, respectively configured to check for other types of errors listed above, or for types of errors that are not referred to herein but would occur to those of skill in the art. The error classes listed above are described more fully as follows:

Package Completeness—This is done to confirm that all files originally delivered to translator 104 for translation are received back at tool 106, in translated form. For example, file 102 may be one of fifty-three files contained in a package sent to translator 104, for translation from the original natural language. The package completeness check would confirm that fifty-three translated files (including file 102), that respectively correspond to the originally sent files, were all received back from the translator at tool 106.

Package Correctness—This type of error search is performed to confirm that file names have not been changed by the translator 104. This is important, because most software development environments are very sensitive to changes of things such as the case of file names, and the set of folders that a file is contained in. For example, if a delivered file is inside a set of folders so that the entire name of the file is src/com/ibm/example/patent/Disclosure/test.properties, the error checking device would seek to confirm that in the translated file, the name of the file has not been changed, for example, to src/com/ibm/example/patent/Disclosure/TEST.PROPERTIES, or to Src/Com/Ibm/Example/Patent/Disclosure/Test.properties. The error checking device would also indicate that the file name was not returned without all of the enclosing folders, for example, test.properties, if this were to occur.

Code Content Comparison—Frequently, files that are sent to translator 104 for translation include pieces of a software product that do not need translation, together with strings or the like that do need to be translated into the new natural language. Such combination of file elements is sent so that the end user will be able to view the product graphic user interface (GUI) in his/her own language, when running the product in a localized environment that is different from the one that the software was developed in. An error checking device performing this type of error search would compare the translated file to the original language (e.g., English) file that had been delivered to translator 104 for translation, and would confirm that the translator 104 had only changed the sections of the file that are truly translatable, and did not attempt to change any of the software code included in the file that is not translatable.

Syntax Checking—Most software programming languages have a very specific structure that must be followed in order for the translated file to be valid. Accordingly, one of the error checking devices of tool 106 would usefully be configured to determine what programming language the file was associated with, and then examine the contents of the file to ensure that it conformed to the rules applicable for that programming language.

Workable Compilation Testing—Certain files sent for translation contain code or need to be included into a software product through a compilation or build process. For such files, an associated error checking device would attempt to compile or build the entire product (or if possible just the single file) to ensure that it was successful with the inclusion of the translated file.

Codeset (encoding) Confirmation—At the lowest level, the letters and characters viewed on a computer screen are represented by particular combinations of bytes of information. However, the same byte sequence can mean many different things, depending on the encoding. For example, the pair of hexadecimal values --E3 5C-- can be interpreted in many different ways. This pair of byte values is interpreted as γ\in Greek UNIX 8859-7 and as ι\ in Greek IBM 869. The same pair of byte values is interpreted to represent different letters in Latin 1 IBM 850 and in Latin 1 UNIX 8859-1, MS 1252, and to represent different characters in Chinese IBM/MS 936 (GBK), Chinese IBM/MS 950 (BIG5), and Japanese IBM/MS 932 (SJIS). Moreover, within each regional script (e.g., Latin 1, Cyrillic, Chinese, Greek, Japanese) there can be different character encodings for each of the following categories: IBM PC code pages (sometimes more than one per script); IBM EBCDIC code pages (often many for each script); Microsoft Windows code pages; UNIX Standard code sets; and other proprietary encodings (e.g., HP Roman8).

In view of the above information regarding codesets, it is very important to ensure that each translated file is using the correct set of bytes to represent the translated text. Accordingly, an error checking device configured to perform this task is provided with an input comprising a set of assumptions, such as what language the file has been translated into, and what operating system it is meant to run on. The codeset confirmation error checking device would then analyze the file, to confirm that the set of bytes that it sees inside the file are valid to represent linguistic characters in that particular language/operating system combination.

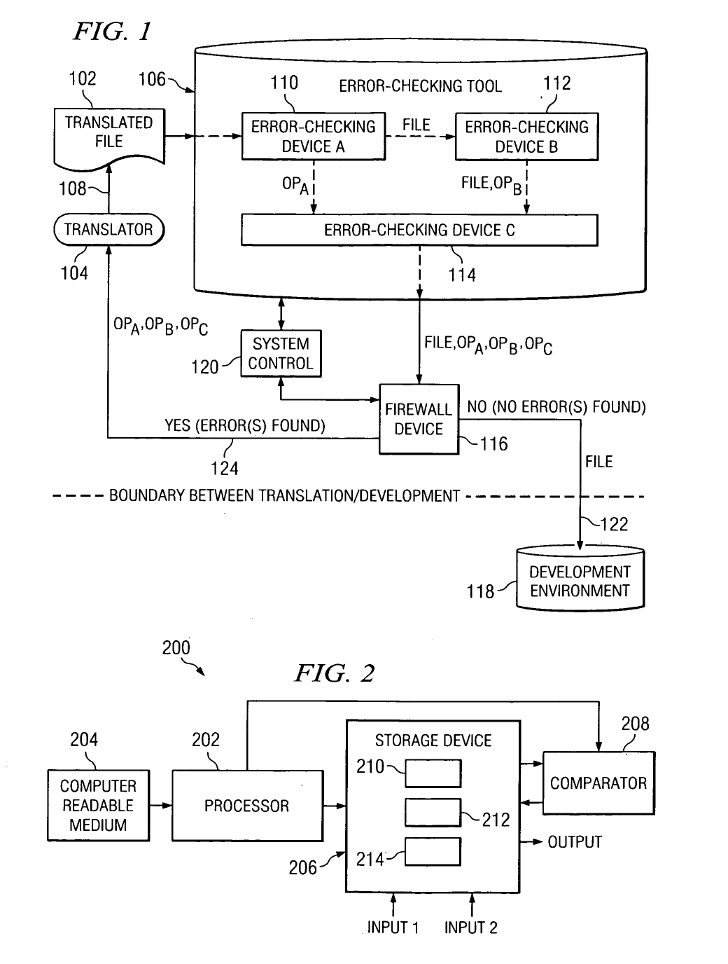

Referring to FIG. 2, there are shown respective components for a simplified error checking device 200, which may be used for one of the devices 110-114 of FIG. 1. Error checking device 200 includes a processor 202, a computer readable medium 204 coupled to the processor, and a storage device 206 and a comparator 208 that are both coupled to processor 202 and interconnected to one another. Storage device 206 is provided with distinct storage locations 210-214, and is further provided with an Input 1 and an Input 2.

For operation as an error checking device, the computer readable medium 204 is provided with a software program configured to direct operation of respective components of device 200. Initially, translated file 102 is entered into storage device 206, through Input 1 or the like, and stored at one of the storage locations such as location 210. Other information needed to carry out an error checking task on translated file 102 is entered into storage device 206 through Input 2 and stored at a storage location such as 212. Such other information could include, for example, a copy of the software file in its original natural language, that is, prior to the translation that generated file 102. For some types of error checking, the other information could include assumptions of the type referred to above, such as the operating system that the translated file was intended to run on.

To check translated file 102 for errors, the software in computer readable medium 204 would direct processor 202 to parse the file 102 stored at location 210, and to load a portion of the parsed file into comparator 208. Other information could then be loaded into comparator 208 from the storage location 212. For example, if device 200 is configured to check for errors associated with code content, a portion of the translated file 102 would be loaded into comparator 208, and compared with the corresponding portion of the original language file in storage location 202. The comparator 208 could then determine whether any erroneous attempts had been made to translate software code elements from the original file that were in fact untranslatable. Respective results produced by operation of comparator 208 would be stored in storage device 206 such as at location 214. At the conclusion of the error checking procedure, processor 202 would direct storage device 206 to generate an output indicating any errors that had been discovered in the translated file 102.

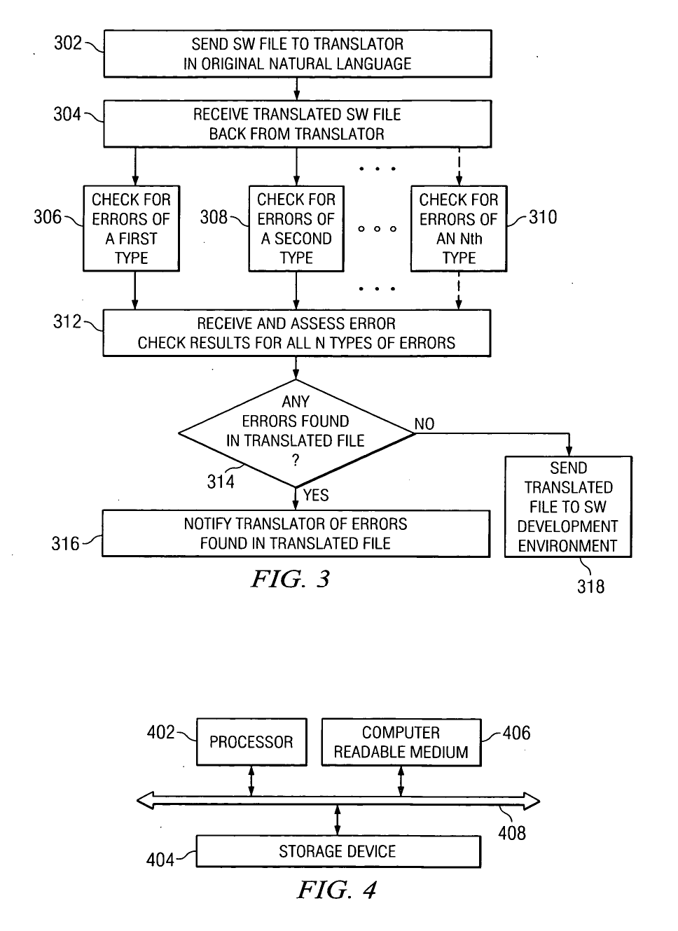

As indicated by function block 302 of FIG. 3, a software file in an original natural language is initially sent to translator 104 or the like for translation. The file is then translated into a selected new natural language and received back from the translator, as shown by function block 304. Thereupon, the translated file is checked for up to N different types of errors, where N is at least two and can extend upward therefrom to any reasonable number. This is shown by function blocks 306-310.

Referring further to FIG. 3, function block 312 indicates that the results of the searches for all N types of errors are analyzed. If any errors have been found in the translated file, the translator is notified of the errors, as shown by decision block 314 and function block 316. The translator may then correct the translated software and return it for further checking. If and only if no errors have been found in the translated software file, the translated file will be sent to the software development environment for use therewith, as shown by function block 318.

Referring to FIG. 4, there is shown a simplified configuration of a control system 120 for an embodiment of the invention. Control system 120 comprises a processor or processing unit 402, a data storage device 404 and a computer readable medium 406. Components 402-406 are interconnected by means of a bus 408. Processing unit 402 could, for example, comprise a wide range of processors and ASIC devices. Computer readable medium 406 could comprise, for example, a recordable medium or media, such as a hard disk drive, floppy disk, a RAM, CD-ROMS, or DVD-ROMs, but is by no means limited thereto. Medium 406 is provided with processor instructions configured to be read by processor 402, and to thereby cause said processor to operate error checking tool 106, error checking devices 110-114 and firewall device 116 as described above.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMS, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A system for checking a software file translated into a specified natural language comprising:
a plurality of error checking devices respectively coupled to receive said file translated into said natural language, said plurality including a first error checking device disposed to provide a first output indicating whether any portion of said translated file has a first type of error;
a second error checking device included in said plurality disposed to provide a second output indicating whether any portion of said file translated into said natural language has a second type of error that is different from said first type of error; and
a firewall device responsive to said first and second outputs to prevent said file translated into said natural language from entering a software development environment when either of said outputs indicate that one or more translation errors has been found in said translated file.

2. The system of claim 1 wherein:
said translated file comprises information translated into a first human language from a second human language by a translator.

3. The system of claim 2 wherein:
said firewall device is adapted to automatically notify said translator of any error found in said translated file by any of said plurality of error checking devices.

4. The system of claim 3, wherein:
a separate error checking device is provided to search said translated file for each of a plurality of different types of errors included in a set of types of errors.

5. The system of claim 4, wherein:
said set includes at least errors respectively pertaining to package completeness, package correctness, code content, syntax, correct encoding and workable compilation.

6. The system of claim 3, wherein:
a bidirectional communication path is provided between said system and said translator.

7. The system of claim 6, wherein:
at least a portion of said bidirectional path is routed over the Internet.

8. The system of claim 3, wherein:
said translated file is transmitted sequentially from one of said error checking devices to another of said error checking devices.

9. A method for checking a software file translated into a specified natural language by a translator comprising the steps of:
performing a first error checking task to provide a first output indicating whether any portion of said file translated into said natural language has a first type of error;
performing at least a second error checking task to provide a second output indicating whether any portion of said file translated into said natural language has a second type of error that is different from said first type of error;
sending the file translated into said natural language to a software development environment when no errors are found in said translated file during the performance of any error checking task; and
notifying said translator of any errors found during the performance of any error checking task.

10. The method of claim 9 wherein:
said translated file comprises information translated into a first human language from a second human language by said translator.

11. The method of claim 10, wherein:
a separate error checking task is performed to search said translated file for each of a plurality of different types of errors included in a set of types of errors.

12. The method of claim 11, wherein:
said set includes at least errors respectively pertaining to package completeness, package correctness, code content, syntax, correct encoding and accurate compilation.

13. The method of claim 10, wherein:
a bidirectional communication path is provided between said translator and a location for performing said error checking tasks.

14. The method of claim 13, wherein:
at least a portion of said bidirectional path is routed over the Internet.

15. A computer program product in a computer readable medium for checking a software file translated into a specified natural language comprising:
a first instruction for performing a first error checking task to provide a first output indicating whether any portion of said file translated into said natural language has a first type of error;
a second instruction for performing second error checking task to provide a second output indicating whether any portion of said file translated into said natural language has a second type of error that is different from said first type of error; and
a third instruction for preventing said file translated into said natural language from entering a software development environment when either of said outputs indicates that one or more translation errors has been found in said translated file.

16. The computer program product of claim 15 wherein:
said translated file comprises information translated into a first human language from a second human language by a translator.

17. The computer program product of claim 16 wherein:
said computer program product includes a fourth instruction to notify said translator of any error in said translated file indicated by either of said outputs.

18. The computer program product of claim 17, wherein:
a separate error checking task is performed to search said translated file for each of a plurality of different types of errors included in a set of types of errors.

19. The computer program product of claim 18, wherein:
said set includes at least errors respectively pertaining to package completeness, package correctness, code content, syntax, correct encoding and accurate compilation.

20. The computer program product of claim 19, wherein:
a bidirectional communication path is provided between said system and said translator at least a portion of said bidirectional path being routed over the Internet.
